(19) United States
(12) Patent Application Publication
(10) Pub. No.: US 2007/0024586 A1
(43) Pub. Date: Feb. 1, 2007

(54) Pen like optical mouse

(76) Inventors: Kuo-Wen Chang, Hsinchu (TW); Ming-Sen Tsao, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/189,678

(22) Filed: Jul. 26, 2005

(51) Int. Cl. G09G 5/08

(52) U.S. Cl. 345/166

(57) ABSTRACT

A pen like optical mouse includes a pen like mouse main body, a printed circuit board disposed in the main body in a direction parallel to a central axis of the main body, a light emitting element mounted on the first printed circuit board, a sensor die mounted on the second printed circuit board, and an imaging system for guiding light emitted from the light emitting element to be irradiated onto and reflected by a work surface and then guiding the reflected light so as to be imaged and incident on the sensor die. As the light emitting element and the sensor die are arranged on two separate printed circuit boards, light emitted from the light emitting element is prevented from being directly incident on the senor die so as not to reduce the contrast of images.

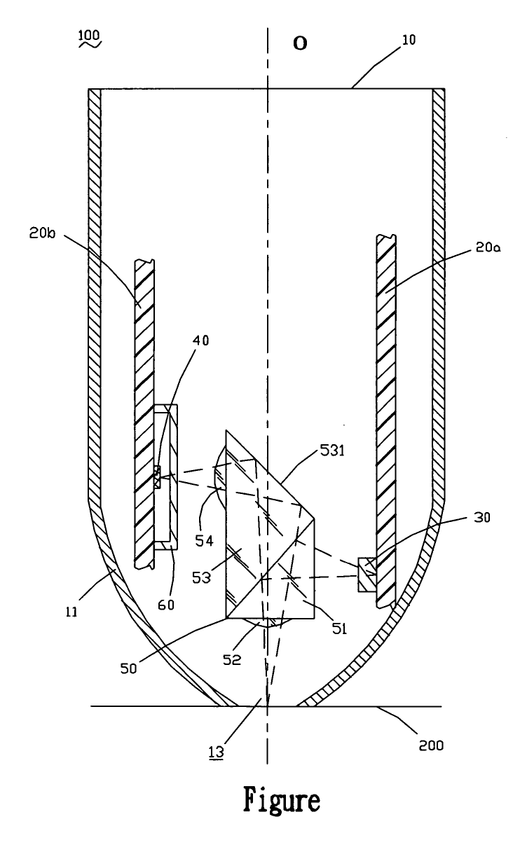

### BACKGROUND OF THE INVENTION

1. Field of the Invention

The present invention relates to an optical mouse, and more particularly, to a pen like optical mouse in which light emitted from a light emitting element is prevented from being directly incident on a sensor die, thus ensuring the performance of the pen like optical mouse by not reducing the contrast of images.

2. The Related Art

A mouse, which is one of the input means for computers, is a device that is used to directly or indirectly instruct a computer on the coordinates of a cursor displayed on a monitor of a computer. Such mice are classified into two types; ball mice that each inputs the moving direction and distance of the mouse by utilizing the rotation of a ball, and optical mice that each detects the moving direction and distance of the mouse by tracing the movement of the images of a work surface formed by light emitted from the mouse body.

As need not to be periodically cleaned and have other well-known advantages, optical mice become more and more popular. In order to perform natural writing and drawing operation with the optical mice, pen like optical mice have been developed.

A conventional pen like optical mouse includes a cylindrical body, an illumination source, a lens, and an optical motion sensor. The illumination source emits light, and the lens allows reflected light, which is generated when the light emitted from the illumination source is reflected off a work surface, to be imaged. Then, when a series of images of the work surface imaged through the lens are captured with the optical motion sensor, a direction and amount of movement of the mouse are obtained from variations in the images due to motion of the mouse. However, in order to image the reflected light from the work surface and capture the images, the lens and the optical motion sensor are arranged facing to the work surface, that is, are arranged in a direction perpendicular to a central axis of the body. The dimension of the optical motion sensor in the direction perpendicular to the central axis of the body is relatively longer than that in a direction parallel to the central axis. Therefore, the arrangement of the optical motion sensor in such manner results in enlargement of the diameter of the mouse. It is difficult to use the mouse while holding in one's hand.

Another conventional pen like optical mouse is described in Pub. No. US 2003/0112220 by Yang et al., published on Jun. 19, 2003. The conventional pen like optical mouse includes a pen like mouse main body, an illumination unit, an imaging system, an image sensor and a control means. The imaging system is capable of changing a path of the reflected light in addition to imaging light so that the reflected light can be received by the image sensor. So the image sensor and the control means are permitted to be disposed on a side of the interior of the main body parallel to a central axis of the main body to overcome the above-mentioned problem. However, the illumination unit and the image sensor are arranged adjacent to each other, and have no structure or means blocked therebetween. Thus, some light emitted from the illumination unit is inevitably and directly incident on the image sensor, which reduces the contrast of images and, in turn, affects the performance of the pen like optical mouse.

In view of the above, an improved pen like optical mouse that overcomes the above-mentioned problems is strongly desired.

### SUMMARY OF THE INVENTION

An object of the present invention is to provide pen like optical mouse in which light emitted from a light emitting element is prevented from being directly incident on a sensor die, thus ensuring the performance of the pen like optical mouse.

In order to accomplish the above object, the present invention provides a pen like optical mouse for enabling the position of the cursor to be displayed on a monitor of a computer by detecting its own movement using reflected light, comprising:
a pen like mouse main body having a central axis and a pen head at a lower end of the main body, an opening being defined in bottom of the pen head;
a first printed circuit board disposed on a side of the interior of the main body and in a direction parallel to the central axis of the main body;
a second printed circuit board disposed on another side of the interior of the main body and in a direction parallel to the central axis of the main body;
a light emitting element mounted on the first printed circuit board for emitting light;
a sensor die mounted on the second printed circuit board, the sensor die comprising an image sensor and an image processing unit; and
an imaging system for guiding light emitted from the light emitting element to pass through the opening and then be irradiated onto and reflected by a work surface, and for guiding the reflected light so as to be imaged and then be incident on the image sensor, the image sensor sensing the light incident thereon and converting the light into electrical signals to be transmitted to the image processing unit, the image processing unit calculating coordinate values of the cursor displayed on the monitor based on the converted electrical signals from the image sensor.

Since the light emitting element and the sensor die are arranged on two separate printed circuit boards, the light emitting element and the sensor die are properly distanced, thus light emitted from the light emitting element is prevented from being directly incident on the senor die. Accordingly, the contrast of the images is not reduced, and performance of the pen like optical mouse is ensured.

Preferably, the imaging system includes a first positive lens facing to the work surface for converging the light emitted from the light emitting element so that the light is approximately perpendicularly incident on the work surface, thereby increasing the brightness of the light and increasing the sensing efficiency of the optical mouse.

Other objects, advantages and novel features of the invention will become more apparent from the following detailed description of a preferred embodiment thereof when taken in conjunction with the accompanying drawing, wherein:

### BRIEF DESCRIPTION OF THE DRAWING

The FIGURE is a cross-sectional view of a pen like optical mouse in accordance with the present invention.

### DETAILED DESCRIPTION OF THE PREFERRED EMBODIMENT

Referring to the FIGURE, a pen like optical mouse 100 in accordance with the present invention includes a pen like mouse main body 10, a first printed circuit board 20a, a second printed circuit board 20b, a light emitting element 30, a sensor die 40, an imaging system 50, and an aperture 60.

The main body 10 of the optical mouse 100 is shaped like a pen with a tapered pen head 11 at a lower end thereof such that a user can conveniently grasp it and perform natural writing operation. An opening 13 is defined in the bottom of the pen head 11. The main body 10 has a central axis O.

The first printed circuit board 20a is disposed on a side of the interior of the main body 10 and in a direction parallel to the central axis O of the main body 10.

The light emitting element 30 is mechanically mounted on the first printed circuit board 20a and electrically connected to the first printed circuit board 20a. The light emitting element 30 is activated to emit light by manual control or when the pen head 11 is sensed to come into contact with a work surface 200.

The second printed circuit board 20b is disposed on another side of the interior of the main body 10 and in a direction parallel to the central axis O of the main body 10. Preferably, the first and second printed circuit boards 20a, 20b are parallel with each other.

The sensor die 40 is mechanically mounted on the second printed circuit board 20 and electrically connected to the second printed circuit board 20b. Therefore, the sensor die 40 and the light emitting element 30 are permitted to be properly distanced. The senor die 40 includes an image sensor for detecting light converged by the imaging system 50 and converting the light into electrical signals and an image processing unit for processing the electrical signals.

The aperture 60 is mounted on the second printed circuit board 20b and positioned on the sensor die 40 to permit the light from a predetermined scope to pass therethrough, thereby rejecting the undesired light. Concretely, the aperture 60 primarily allows the light converged by the imaging system 50 to pass therethrough to be incident on the image sensor.

The imaging system 50, which is disposed between the first and second printed circuit boards 20a, 20b, serves as a light guide and imaging images for guiding light emitted from the light emitting element 30 to pass through the opening 13 and then be irradiated onto and reflected by the work surface 200, and for guiding the reflected light so as to be imaged and then be incident on the image sensor. The imaging system 50 comprises a first prism 51, a first positive lens 52, a second prism 53, and a second positive lens 54, each of which is fabricated from transparent material, such as transparent plastic or the like. The first prism 51 has a surface facing to the light emitting element 30 and another surface facing to the opening 13 for guiding light emitted from the light emitting element 30 to pass through the opening 13 and be irradiated onto the work surface 200. The first positive lens 52 is cemented to the surface of the first prism 51 facing to the opening 13 for converging light emitted from the light emitting element 30 so that the light is approximately perpendicularly incident on the work surface 200. The second prism 53 has a surface cemented to the first prism 51 and another surface facing to the image sensor. The second positive lens 54 is cemented to the surface of the second prism 53 facing to the image sensor for converging light on the image sensor. The second prism 53 further has a reflection surface 531 inclined at an angle capable of reflecting the light reflected by the work surface 200 toward the second positive lens 54 by which the reflected light is imaged. In brief, the second prism 53 and the second positive lens 54 function as guiding the reflected light reflected by the work surface 200 to be imaged on the image sensor. Preferably, the second prism 53 is configured to meet the total internal reflection requirement to prevent the light reflected by the work surface 200 from leaking out from the second prism 53. It will be appreciated that, alternatively, the reflection surface 531 is plated with a coating on an outer side thereof to function as a mirror to prevent the light from leaking out from the second prism 53.

When the light reflected by the work surface 200 is incident on the image sensor, the image sensor senses an image of the work surface 200 and converts the image into electrical signals. Then the electrical signals are transmitted to the image processing unit. The image processing unit calculates coordinate values of the cursor displayed on the monitor based on the converted electrical signals from the image sensor. Then the coordinate values are transferred to the computer.

It can be seen from the described-above, the sensor die 40 and the light emitting element 30 are arranged on two separate printed circuit boards 20a, 20b, the light emitting element 30 and the sensor die 40 are properly distanced, thus light emitted from the light emitting element 30 is prevented from being directly incident on the senor die 40. Accordingly, the contrast of the images is not reduced, and performance of the pen like optical mouse 100 is ensured.

Furthermore, the light converged by the first positive lens 52 is approximately perpendicularly incident on the work surface 200, thereby increasing the brightness of the light and increasing the sensing efficiency of the optical mouse 100.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to a person skilled in the art are intended to be included within the scope of this invention as defined by the accompanying claims.

What is claimed is:

1. A pen like optical mouse for enabling the position of the cursor to be displayed on a monitor of a computer by detecting its own movement using reflected light, comprising:
a pen like mouse main body having a central axis and a pen head at a lower end of the main body, an opening being defined in bottom of the pen head;
a first printed circuit board disposed on a side of the interior of the main body and in a direction parallel to the central axis of the main body;
a second printed circuit board disposed on another side of the interior of the main body and in a direction parallel to the central axis of the main body;
a light emitting element mounted on the first printed circuit board for emitting light;
a sensor die mounted on the second printed circuit board, the sensor die comprising an image sensor and an image processing unit; and
an imaging system for guiding light emitted from the light emitting element to pass through the opening and then be irradiated onto and reflected by a work surface, and for guiding the reflected light so as to be imaged and then be incident on the image sensor, the image sensor sensing the light incident thereon and converting the light into electrical signals to be transmitted to the image processing unit, the image processing unit calculating coordinate values of the cursor displayed on the monitor based on the converted electrical signals from the image sensor.

2. The pen like optical mouse as claimed in claim 1, wherein the imaging system comprises a first prism for guiding light emitted from the light emitting element to pass through the opening and be irradiated onto the work surface.

3. The pen like optical mouse as claimed in claim 2, wherein the imaging system further comprises a first positive lens cemented to the first prism and facing to the work surface for converging the light so that the light is approximately perpendicularly incident on the work surface.

4. The pen like optical mouse as claimed in claim 2, wherein the imaging system further comprises a second prism cemented to the first prism for guiding the reflected light reflected by the work surface to be imaged.

5. The pen like optical mouse as claimed in claim 4, wherein the imaging system further comprises a second positive lens cemented to the second prism and facing to the image sensor for converging the reflected light onto the image sensor.

6. The pen like optical mouse as claimed in claim 5, wherein the second prism has a reflection surface inclined at an angle capable of reflecting the light reflected from the work surface toward the second positive lens.

7. The pen like optical mouse as claimed in claim 6, wherein the second reflection surface is plated with a coating on an outer side thereof.

8. The pen like optical mouse as claimed in claim 4, wherein the second prism is configured to meet the total internal reflection requirement.

9. The pen like optical mouse as claimed in claim 1, wherein the first and second printed circuit boards are parallel with each other, and the imaging system is disposed between the first and second printed circuit boards.

10. The pen like optical mouse as claimed in claim 1, further comprising an aperture installed on the second printed circuit board and located on the image sensor.
